(19) United States
(12) Patent Application Publication
(10) Pub. No.: US 2013/0087709 A1
(43) Pub. Date: Apr. 11, 2013

(54) MERCURY GAS SENSING USING TERAHERTZ TIME-DOMAIN SPECTROSCOPY

(71) Applicant: Heidy Hodex Visbal Mendoza, Nara-shi (JP)

(72) Inventor: Heidy Hodex Visbal Mendoza, Nara-shi (JP)

(21) Appl. No.: 13/555,591

(22) Filed: Jul. 23, 2012

(30) Foreign Application Priority Data
Oct. 7, 2011 (US) PCT/US2011/055240

(51) Int. Cl. G01N 21/61

(52) U.S. Cl. 250/339.13

(57) ABSTRACT

Disclosed are methods and apparatuses for detecting mercury species in various gas streams, such as those generated from fossil fuel combustion.

### CROSS-REFERENCE TO RELATED APPLICATIONS

This application claims the benefit of International Application Serial No. PCT/US2011/055240, filed on Oct. 7, 2011, the entire disclosure of which is hereby incorporated by reference for all purposes in its entirety as if fully set forth herein.

### TECHNOLOGY

The present technology is related in general to spectroscopic devices and methods for the detection of mercury.

### BACKGROUND

The following discussion of the background is merely provided to aid the reader in understanding the technology and is not admitted to describe or constitute prior art to the present application.

Mercury is a trace component of all fossil fuels. The use of fossil hydrocarbons as fuels provide emissions of the mercury to the atmospheric environment. The mercury from fossil fuel combustion typically enters the environment as Hg⁰ (g), or as an organomercury compound such as methyl mercury.

The detection of mercury in the atmosphere is receiving increased importance, because of the toxicity of organomercury compounds and the associated adverse health effects. However, low concentrations of gaseous mercury are difficult to detect directly by spectroscopic methods such as ultraviolet, visible, infra-red, or x-ray spectroscopies, especially when the mercury is in the presence of hydrocarbon gases. The difficulty arises from interference by the hydrocarbon in the various detection regions of the spectrum. As such, the most commonly used techniques for mercury detection require its pre-concentration on gold traps, and while the sensitivity of such techniques is more than adequate for concentration measurements, the response time can be several minutes. This lagging response time is inadequate, as mercury can undergo fast atmospheric cycling. Accordingly, methods of direct detection and quantification of mercury are needed, in particular where the mercury may be in the presence of hydrocarbon gases.

### SUMMARY

In accordance with one aspect, a method is provided, including: irradiating a gas stream with terahertz radiation from a terahertz emitting source; obtaining a rotational terahertz spectrum of the gas stream; and determining a presence or absence of mercury or a mercury-containing species in the gas stream. In some embodiments, the method further includes quantifying the mercury in the gas stream. In some embodiments, the gas stream is a flue gas stream, such as from a fossil fuel combustion process. In some such embodiments, the flue gas stream is from the combustion of coal.

In some embodiments, the mercury, when present in the gas stream, is present as a Hg° species or as an organomercury compound. In some embodiments, the mercury is present as an organomercury compound which is methyl mercury. In some embodiments, the concentration of the mercury in the gas stream is from about 1 ppm to about 10 wt %.

In some embodiments, the terahertz radiation is at a frequency from about 0.1 THz to about 10 THz. In other embodiments, the rotational spectrum shows an absorption from about 0.1 THz to about 10 THz.

In another aspect, an apparatus is provided including: an ultrafast, pulsed laser generator; a first conduit configured to convey a laser pulse from the ultrafast, pulsed laser generator to a beam splitter; the beam splitter configured to split the laser pulse into a reference beam and an excitation beam; a second conduit to convey the reference beam to a time-delay generator; a third conduit to convey the excitation beam to a THz emitter configured to emit THz radiation upon excitation by the excitation beam; a sampling region in a flue gas stream through which the THz radiation is be emitted; a detector; and an amplifier. In some other embodiments, the first conduit, the second conduit, and the third conduit are fiber optic conduits.

In some embodiments, the THz emitter includes a direct-gas semiconductor including an antenna structure of a high-impedance dipole emitter lithographically defined on a surface of a substrate. In some such embodiments, the THz emitter further includes Ga, As, Al, In, Zn, Se, Te, Li, or Nb, or a mixture of any two or more thereof, or an alloy thereof. In other embodiments, the THz emitter comprises GaAs, AlGaAs, InN, InAs, InGaAs, ZnSe, LiNbO₃, GaBiAs, or ZnTe.

In some embodiments, the apparatus is configured to monitor a flue gas stream in real-time. In some embodiments, the apparatus configured to store or display flue gas mercury concentration data. In some such embodiments, the data is stored or displayed as function of time. In other embodiments, the apparatus is configured to issue an alert or notification.

### BRIEF DESCRIPTION OF THE DRAWINGS

FIG. 1 is a general schematic illustration of a terahertz spectrometer for analysis of a sample, according to one embodiment.

FIG. 2 is a general schematic illustration of a terahertz spectrometer for analysis of a flue gas sample, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The present technology is also illustrated by the examples herein, which should not be construed as limiting in any way.

Unless context dictates otherwise, as used herein, the term “mercury” and “mercury-containing species” refers to any type of mercury or mercury compound (either ionic or covalent), and further includes substances which include mercury in any oxidation state, as will be appreciated by persons of ordinary skill in the art. In this regard, mercury may be present in a zero oxidation state (i.e., Hg⁰, such as metallic mercury, or Hg⁰ covalently bonded to neutral ligands), or mercury may be present in an oxidized form, such as in Hg(I) or Hg(II). Examples of mercury compounds, include, but are not limited to, mercury(I) chloride, mercury(II) chloride, mercury(I) bromide, mercury(II) bromide, mercury(I) iodide, mercury(II) iodide, mercury(I) sulfate, mercury(II) sulfate, mercury(I) nitrate, mercury (II) acetate, mercury(II) benzoate, mercury(II) iodate, mercury(II) cyanide, mercury(II) oxide (including both red mercury(II) oxide and yellow mercury(II) oxide), mercury(II) sulfide, as well as organomercury compounds, including but not limited to, diphenylmercury(II), phenylmercuric acetate, phenylmercuric hydroxide, dimethylmercury(II), methymercuric bromide, methylmercuric chloride, and the like. The term “mercury-containing species” further include those species which may be transiently formed, unisolable, or otherwise not stable at those temperatures and pressures found in a typical laboratory environment.

In one aspect, an apparatus is provided for detecting mercury in a sample. While the apparatus may be used for the detection of mercury in a wide variety of samples, gas streams which are exhausted to the environment are one such type of sample in which it is important to monitor the presence and amount of mercury. One illustrative gas stream is a flue gas stream. For example, the apparatus may be used for the detection of mercury in flue gas streams associated with the combustion of fossil fuels, fossil fuel reforming, or fossil fuel gasification. In one illustrative example, it is the flue gas stream associated with a coal-fired power plant. The flue gas stream may also be associated with a waste-incinerator. As used herein, the term “flue gas” or “flue gas stream” broadly refers to the exhaust gas from any sort of combustion process, including, but not limited to the combustion of coal, oil, natural gas, etc. Flue gas streams typically include gases such as CO, CO₂, SO₂, SO₃, HCl, NOₓ (e.g., NO, NO₂), water, etc.

The apparatus includes a terahertz (THz) spectrometer that is configured to monitor a sample, using time-domain spectroscopy (TDS). The THz region of the electromagnetic spectrum is defined herein as the frequency range from 0.1 THz to 10 THz, which is located between the microwave and the infrared (IR) regions of the electromagnetic spectrum. Within the THz region, the line shapes of the transmissions/absorbances tend to simplify considerably as compared to the IR region. This is due to the fact that the spectral absorbances in the THz region are purely rotational in origin. In many cases, these spectra can be characterized by a small number of rotational energy parameters. Thus, characterization of more complex molecules is frequently easier with pure rotational spectra than it is when vibrational levels are also excited. As used herein, absorbance is typically the reported value from such spectral determinations, however the instruments typically monitor the transmission. The absorbance and transmission are, however, related as: A 32 2−log T, where A is absorbance and T is transmission. Thus, a graph of absorbance versus concentration is linear, whereas a graph of transmission versus concentration is logarithmic.

The apparatus can be used as a positive control to detect mercury in a sample and can provide information regarding the concentration of the mercury. In THz region, mercury may be detected more efficiently or accurately by relying on the relatively simple rotational or translational spectra of mercury and mercury compounds, rather than on more complex vibrational signatures. Other advantages include the great flexibility afforded by the extremely broad bandwidth accessible with terahertz time-domain spectroscopy (TTDS), and coherent detection, which permits far-infrared spectroscopic measurements of plasmas, flames, and other challenging samples. Furthermore, in contrast with conventional IR-based spectroscopic techniques which may require pre-filtration of particulate-containing samples (e.g., combustion gases) as to avoid obscuring the optical path, TTDS offers the potential to provide direct and near-simultaneous measurements of gaseous samples contaminated with aerosols and other particulates, such as is found in combustion gases. See Uno, T. et al. Jpn. J. Appl. Phys. 49, 04DL17 (2010).

Thus, in some embodiments, the terahertz spectrometer monitors the terahertz region of the electromagnetic spectrum, from 0.1 to 10 THz (terahertz). This region may also be expressed in terms of wavenumbers from 10 to 333.1 cm⁻¹. Monitoring in this region indicates the presence or absence of mercury in the gas stream, and, based upon quantification curves, can provide information regarding the amount of mercury in the gas stream as well. The mercury may be present as Hg⁰ (a non-ionic mercury), or as an Hg-organic compound, one illustrative example of which is methyl mercury ([Hg(CH₃)]X). Methyl mercury is an ionic species where a methyl group is covalently bonded to an Hg(II) atom. The anion, denoted as X, may be any anionic species in the flue gas. The methyl mercury may also exist at any given moment in the flue gas as a charged species unassociated with any particular anion as goes through transitional changes in the flue gas. Where the mercury is present as Hg⁰, the detection is via translational changes in the mercury. In one embodiment, the absorption associated with Hg⁰ occurs between 0.1 and 5 THz. Hg-organic compounds are expected to absorb THz radiation from about 0.1 to about 10 THz.

The sensitivity of the THz spectroscopic measurement is dependent upon the source power and the detector power, both of which are equipment limitations. Thus, the sensitivity and amount of mercury that may be detected will vary from instrument to instrument. However, in some embodiments, the amount of mercury that may be detected is from a lower limit on the ppm scale to several weight percent. Accordingly, in one embodiment the amount of mercury that may be detected may range from about 1 ppm to about 10 wt %. In other embodiments, the amount of mercury that may be detected may range from about 150 ppm to about 1 wt %.

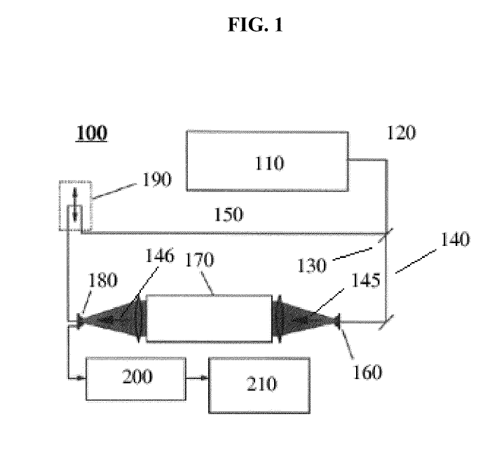

Referring to the figures, a schematic drawing of an apparatus for detecting mercury is provided in FIG. 1. The apparatus 100 relies on an ultrafast laser system 110, producing a train of optical pulses 120, of approximately 100 fs (femtosecond, i.e. 10⁻¹³ s) duration. The pulses are in the near-infrared region of the electromagnetic spectrum. In some embodiments, the pulses are at a wavelength from about 10 cm⁻¹ to about 300 cm⁻¹. The pulse train 120 is then split into an excitation beam 140 and a reference beam 150 by a beam splitter 130. The excitation beam 140 is directed to the THz emitter 160, and reference beam 150 is directed to a time-delay generator 190. The THz emitter 160 includes a direct-gap semiconductor with an antenna structure of a high-impedance dipole emitter lithographically defined on its surface. The high-impedance dipole emitter is DC-biased, to a few tens of volts. When a femtosecond (fs) pulse (e.g., the excitation beam 140) excites the semiconducting material in the antenna with an above band-gap excitation, an THz frequency electromagnetic wave 145 is generated. This photo-generated wave 145 is then accelerated by the applied bias field through the sample cell 170. Upon contact with the sample in the sample cell 170, an absorption of the energy imparted by the wave 145 may, or may not, occur, and a sample-exposed, THz frequency electromagnetic wave 146 exits the sample cell 170 to a THz detector 180, where a current amplifier 200 amplifies the signal, and is converted from an analog to a digital signal by a processor 210 for display. The speed at which these waveforms can be measured depends on several factors, including the speed of the analog to digital conversion, the required signal-to-noise ratio of the measurement, and the speed of the mechanical optical delay line 190. Using a scanning optical delay line 190 (a retroreflector mounted on a galvanometric motor), the THz waveform may be measured in only a few tens of milliseconds with a signal-to-noise in excess of 10³. This fast data acquisition permits rapid analysis of the full spectral bandwidth spanned by the THz pulse, and thus real-time sensing and identification of gases with absorption signatures within the measured bandwidth.

As used herein, the term “real-time” refers to performing a set of operations (e.g., sensing, identifying, and/or quantifying of mercury in gas streams), such that an output or a result of the set of operations is produced based on a particular timing constraint. While an operation is sometimes referred to herein as being performed in real-time, it is contemplated that an output of the operation can be produced with some detectable delay or latency. For example, an operation can be performed in real-time if an output of the operation is produced at a rate that is the same as or substantially the same as a rate at which an input of the operation is acquired. As another example, an operation can be performed in real-time if an output of the operation is produced within a particular upper limit of response time, such as within about 1 minute, within about 45 seconds, within about 30 seconds, within about 20 seconds, within about 10 seconds, within about 5 seconds, within about 1 second, within about 0.1 second, within about 0.01 second, or within about 0.001 second. As a further example, an operation can be performed in real-time if an output of the operation is timely produced so as to be capable of affecting or controlling a process while it is occurring.

The ultrafast lasers include a wide variety of lasers depending upon the wavelength of the pulse desired. For example, Er-doped or Yb-doped lasers may be used, according to some illustrative embodiments. Other lasers include, but are not limited to, Ti:sapphire (gain spectrum: 650-1100 nm), rhodamine 6G (dye; gain spectrum: 600-650 nm), Cr:LiSAF (gain spectrum: 800-1000 nm) and Nd:glass (gain spectrum: 1040-1070 nm). Ultrafast lasers (also known as ultrashort pulse lasers) emit ultrashort pulses of laser irradiation with a duration of femto-, pico-, or nano-seconds. The term ultrafast lasers is often used for mode-locked lasers, although gain switching may also provide ultrashort pulses.

With the regard to the wave 145 being absorbed or not absorbed this is a function of what is contained within the sample, and whether or not there is a component of the sample that absorbs within the THz region that is monitored.

The THz emitter is a direct-gap semiconductor with an antenna lithographically defined on its surface. The antenna is produced by lithographic patterning of two metal electrodes on the surface of a semiconductor substrate. A bias is applied across the two electrodes and a highfield region is generated in the material. When the femtosecond laser is focused in the gap between the two electrodes, electron-hole pairs are generated. These hole pairs are essentially photogenerated carriers which are injected into the high field region end up, and accelerating and drifting in opposite directions depending on whether they are electron or hole charges. As a result of this transport, a space-charge field is generated which screens the bias field. As the light source is a femtosecond laser, a transient current is set up between the two electrodes in regular bursts, causing the electrodes to radiate as a dipole antenna. This phenomena is explained in greater detail in Bergmann, N. W. et al. Proceedings of SPIE Vol. 4591 (2001).

Suitable THz emitters include semiconductors which when activated by an excitation source emit radiation in the THz region of the electromagnetic spectrum. Illustrative materials include, but are not limited to GaAs, AlGaAs, InN, InAs, InGaAs, ZnSe, LiNbO₃, GaBiAs, and ZnTe, among others.

In one embodiment, an apparatus, such as that illustrated in FIG. 1, is configured to detect mercury in a flue gas sample. As illustrated in FIG. 1, the flue gas may be sampled and the sample contained with the sample cell 170 located between the THz emitter 160 and the THz detector 180. Such an apparatus may allow for detection at various sample times, or at various sample intervals. For such an apparatus, the flue gas is sampled and the sample is placed in the spectrometer.

In another embodiment, the apparatus is configured to detect mercury in a flue gas stream in real-time. In such embodiments, the apparatus is similar to the one illustrated in FIG. 1, except the sample cell is replaced by fiber optic connections which are placed within the flue gas stream. Thus, after excitation by a pulsed laser source, a THz emitter emits an electromagnetic wave that is directed to a fiber optic where it is conveyed to the flue gas stream. In the flue gas stream, the electromagnetic wave passes through a selected segment of the gas before it is again conveyed to a receiving fiber optic which then conveys the wave to a THz detector.

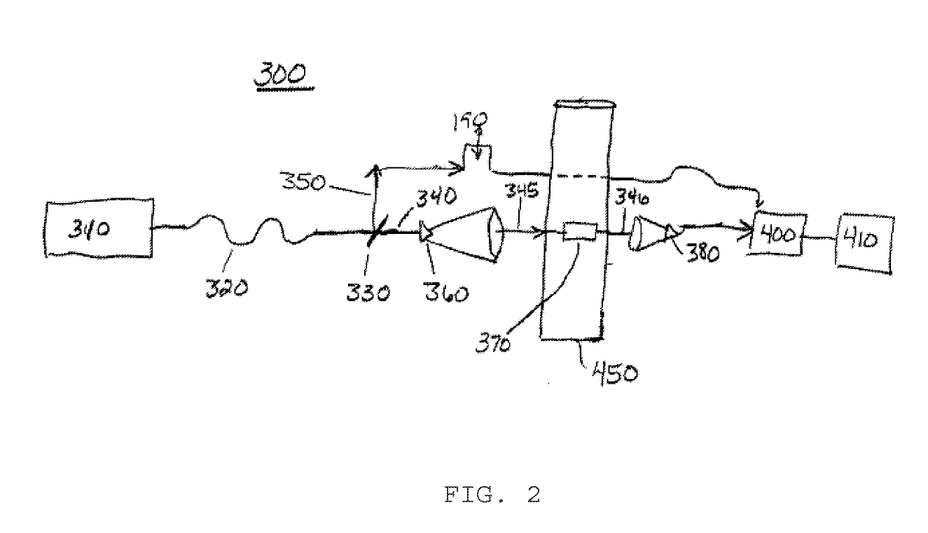

An apparatus for real-time monitoring of a flue gas is illustrated in FIG. 2. FIG. 2 is a general illustration of the apparatus 300 wherein the an ultrafast laser system 310, producing a train of optical pulses 320, of approximately 100 fs (femtosecond, i.e. 10⁻¹³ s) duration. The pulses and waves described for the apparatus 300 are carried, at least in part, by conduits that may be fiber optic cables directing the pulses from the laser system 310 to a flue 450 carrying a flue gas stream. The pulses are in the near-infrared region of the electromagnetic spectrum. The pulse train 320 is then split into an excitation beam 340 and a reference beam 350 by a beam splitter 330. The excitation beam 340 is directed to the THz emitter 360, and the reference beam 350 is directed to a time-delay generator 390. The THz emitter 360 includes a direct-gap semiconductor as described above. When a femtosecond (fs) pulse (e.g., the excitation beam 340) excites the semiconducting material in the antenna with an above band-gap excitation, an THz frequency electromagnetic wave 345 is generated. This photo-generated wave 345 is then accelerated by the applied bias field and into a flue 450, in which a sample region 370 is provided. The sample region 370 is a gap of determined distance that provides an adequate real-time sampling of the flue gas as it moves through the flue. Such distances will be on the order of those as used in bench scale THz instrumentation, however, they may be increased to account for greater distance that the laser or THz signal must travel and concomitant loss of signal in such an apparatus. The reference beam 350 may be conveyed through the flue 450 such that the beam conditions are the same for both beams, except for the passage through the sample region 370. Upon contact with the sample in the sample region 370, an absorption of the energy imparted by the wave 345 may, or may not, occur, and a sample-exposed, THz frequency electromagnetic wave 346 exits the sample region 370 to a THz detector 380, where a current amplifier 400 amplifies the signal, and is converted from an analog to a digital signal by a processor 410 for display.

In another embodiment, the apparatus is configured to store or display data relating to mercury concentration in a gas (e.g., flue gas) as a function of another variable, such as time. The apparatus may be configured to store or display such data with a computer (or a processor such as that indicated in FIGS. 1 and 2), optionally configured to a user interface. For example, the real-time monitoring apparatus previously described may further include a computer workstation configured to store mercury concentration data obtained in real time with the apparatus. Such real time concentration data may be presented to a user in the form of a graph (e.g., displayed through a user interface on the computer workstation), so that the user can monitor changes in mercury emissions of a time period. The apparatus may be further adapted to issue a notification or alert when mercury concentrations deviate from, or reach a predetermined concentration, or deviate from, or reach a predetermined rate of change of concentration. Such notification or alert may be in a variety of forms, such as an audible or visible alarm, an email message, a text message, or the like. For example, in the context of a coal-fired plant, the embodiment of the apparatus thus described can issue an automated notification to an engineer or environmental health and safety officer if the concentrations of mercury in flue gas exceed an acceptable level. As will be appreciated by those of skill in the art, the processor of the apparatus or a computer workstation configured thereto may be configured to operatively communicate with other systems involved in the creation and/or release of mercury in a gas stream, such that the creation and/or release of mercury may be affected or controlled in real-time. For example, the rate of coal combustion may be automatically reduced in response to increased mercury concentrations determined by the apparatus.

In another aspect, a method is provided for the detection and identification of mercury gas and gas mixtures based on terahertz time-domain spectroscopy (TTDS). The methods may be applied to the determination of total mercury content in a gas stream, in real-time, to obtain vital information regarding the gases being vented to the environment from a particular process. The method includes monitoring a sample using TTDS for an absorption in the region of 0.1 to 10 THz, and comparing the absorption to the expected value(s). Spectral absorbances in the THz region are associated with rotational phenomena. Rotational spectra are allowed if the species being detected has a dipole moment and if the polarizability changes during rotation of diatomic molecules. Thus, the following equations may be used to predict absorbance maxima in the THz region for a given species:

$$Δυ = 2 B ( J + 1 ) - {{DJ}^{2} ( J + 1 )}^{2}$$

$$B = \frac{h}{8 {π}^{2} Ic} , \\ I = μ {r}^{2}$$

$$μ = \frac{{m}_{A} {m}_{B}}{{m}_{A} + {m}_{B}}$$

In the equations, the energy levels of a diatomic molecule A-B are treated as a rigid rotor are given in terms of a quantum number J. In the equations, Δv is the rotational line spacing; B is a rotational constant; I is the moment of inertia of the molecule in terms of its reduced mass, μ, and bond length; D is the centrifugal distortion constant (cm⁻¹) which has a value that depends on the rigidity of the molecule and other molecular parameters. Thus, for any given species of interest, including the mercury species described above, the shift of the absorbance in a THz spectrum is indicative of the presence of that particular species in an unknown sample.

For any given species of interest in detection, including the mercury species described above, concentration versus absorption curves may be prepared using samples having a known concentration of the species. Once concentration curves have been prepared, they may be used to identify the species of interest and to quantify the concentration at which it is present.

In view of the shift and concentrations determinations, gaseous samples having unknown mercury compounds at unknown concentrations may be identified and quantified using the described methods. Such mercury compounds may be quantified individually or collectively. Where the gaseous sample is a real-time exhaust gas sample from a fossil fuel combustion operation, the present methods may be used to identify and quantify mercury compounds in the flue gas streams in real-time, and to monitor for changes. Such changes may be indicative of fuel quality variations and combustion efficiencies, and can be used to monitor potential environmental impact of the released mercury.

In addition to simply monitoring the environmental impact of released mercury, the real-time identification and quantification of mercury compounds in gas streams allows for in-process optimization of mercury abatement systems, thereby reducing amount of mercury released to the environment. Currently, the removal or reduction of mercury from flue gas streams in coal-fired plants is commonly effected by direct injection of powdered carbon adsorbents (e.g., activated carbon) into the gas stream, resulting in the sorption of mercury by the carbon adsorbent. The mercury-contaminated carbon adsorbent is captured downstream with particle capture devices such as bag filters (i.e., fabric filters), electrostatic precipitators (ESPs), wet or dry scrubbers, or hybrid systems, thereby reducing the amount of mercury released to the environment. With real-time identification and quantification of mercury in a gas stream, it is possible to quickly optimize mercury abatement systems based on variations of the types or quantities of mercury in the gas stream. For example, a coal-fired plant which employs carbon adsorbents to remove mercury from flue gas streams may vary the amount of carbon adsorbent based upon the identity and quantity of mercury species detected in the flue gas stream using the present methods and apparatuses. Thus, where there is a “spike” in mercury levels in the flue gas stream above a predetermined threshold value, the amount of carbon adsorbent injected into the flue gas stream may be increased to counterbalance the potential increase of mercury released into the environment. Alternatively, where mercury levels fall below a predetermined threshold value, the amount carbon adsorbent injected in the flue gas stream may be decreased. As will be apparent to those of skill in the art, such a process may be readily automated.

The present technology, thus generally described, will be understood more readily by reference to the following examples, which are provided by way of illustration and are not intended to be limiting.

### EXAMPLES

The methods and systems disclosed herein are further illustrated by the following examples, which should not be construed as limiting in any way.

### Example 1

A Yb-doped ultrafast laser is used for light pulse radiation. Fiber optics are used to connect the laser to a beam splitter to direct the pulse as a reference beam and to a GaAs terahertz emitter. The reference beam and generated terahertz pulse is then directed, again using fiber optics, to the flue of a coal-fired power plant. At the flue, the generated terahertz pulse is directed through the gas stream for a defined distance such that it monitors the evolving flue gas in real-time. The pulse is then recollected and sent to a detector, where the reference beam and terahertz pulse are analyzed and converted to an absorption signal.

The absorption signal position and the intensity of the absorption are then to be compared against known compounds and concentration curves of the known compounds to determine both the identity of the species in the flue gas stream and the concentration of those species. Mercury, methyl mercury, and other mercury containing species may be detected.

### Example 2

The monitoring system in Example 1 is configured to transmit real-time flue gas mercury concentration data to a computer workstation. The data is presented visually in the form of a graph on the workstation, allowing the user of the workstation to monitor mercury emissions in the flue gas as a function of time.

### Example 3

The monitoring system in Example 1 is configured to send an automated text message to an engineer when the flue gas mercury concentration exceeds a predetermined threshold value. The engineer then adjusts the mercury abatement systems to improve capture of mercury in the flue gas stream or changes combustion processes to reduce the concentration of mercury in the flue gas stream upon receipt of the text message.

### Equivalents

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

Other embodiments are set forth in the following claims.

What is claimed is:

1. A method comprising:
irradiating a gas stream with terahertz radiation from a terahertz emitting source;
obtaining a rotational terahertz spectrum of the gas stream; and
determining a presence or absence of mercury or a mercury-containing species in the gas stream.

2. The method of claim 1, wherein the terahertz radiation is at a frequency from about 0.1 THz to about 10 THz.

3. The method of claim 1, wherein the rotational spectrum shows an absorption from about 0.1 THz to about 10 THz.

4. The method of claim 1, wherein the mercury, when present in the gas stream, is present as a Hg⁰ species or as an organomercury compound.

5. The method of claim 4, wherein the mercury is present as an organomercury compound which is methyl mercury.

6. The method of claim 1, wherein the gas stream is a flue gas stream from a fossil fuel combustion process.

7. The method of claim 1, wherein the gas stream is a flue gas stream from the combustion of coal.

8. The method of claim 1, wherein the concentration of the mercury is from about 150 ppm to about 1 wt %.

9. The method of claim 1, further comprising quantifying the mercury in the gas stream.

10. An apparatus comprising:
an ultrafast, pulsed laser generator;
a first conduit configured to convey a laser pulse from the ultrafast, pulsed laser generator to a beam splitter;
the beam splitter configured to split the laser pulse into a reference beam and an excitation beam;
a second conduit to convey the reference beam to a time-delay generator;
a third conduit to convey the excitation beam to a THz emitter configured to emit THz radiation upon excitation by the excitation beam;
a sampling region in a flue gas stream through which the THz radiation is be emitted;
a detector; and
an amplifier.

11. The apparatus of claim 10, wherein the first conduit, the second conduit, and the third conduit are fiber optic conduits.

12. The apparatus of claim 10, wherein the THz emitter comprises a direct-gas semiconductor comprising an antenna structure of a high-impedance dipole emitter lithographically defined on a surface of a substrate.

13. The apparatus of claim 12, wherein the THz emitter comprises Ga, As, Al, In, Zn, Se, Te, Li, or Nb, or a mixture of any two or more thereof, or an alloy thereof.

14. The apparatus of claim 12, wherein the THz emitter comprises GaAs, AlGaAs, InN, InAs, InGaAs, ZnSe, LiNbO₃, GaBiAs, or ZnTe.

15. The apparatus of claim 10 configured to monitor the flue gas stream in real-time.

16. The apparatus of claim 10 configured to store or display flue gas mercury concentration data.

17. The apparatus of claim 16, wherein the data is stored or displayed as function of time.

18. The apparatus of claim 16 configured to issue an alert.
